(19) United States
(12) Patent Application Publication
(10) Pub. No.: US 2005/0132100 A1
(43) Pub. Date: Jun. 16, 2005

(54) Method and device capable of sharing inside data of an external USB device

(76) Inventor: Jenna Lai, Taipei (TW)

Correspondence Address: JENNA LAI, P.O. BOX 26-757, TAIPEI, 106, TW

(21) Appl. No.: 10/741,005

(22) Filed: Dec. 12, 2003

(51) Int. Cl. G06F 3/00

(52) U.S. Cl. 710/33

(57) ABSTRACT

The present invention relates a method and device capable of sharing inside data of an externally connected USB device. In this method, by pressing an input bottom, a copy process is initiated for copying and storing the inside data of the externally connected USB device in a network storage device via an USB interface. The network storage device is connected to a local area network via a network interface. The local area network is connected to a plurality of computers. The computer will access the digital data stored in the network storage device via the network interface so as to automatically copy the inside data of the externally connected USB device and achieve the object of sharing the data among the network computers.

### BACKGROUND OF THE INVENTION

1. Field of the Invention

The present invention relates to a method and device capable of sharing the inside data of an externally connected USB device, and particularly, to a method for copying the inside data of an externally connected USB device to a network storage device by means of pressing an input bottom so as to share the data in the computers connected to the network.

2. Description of the Prior Art

Nowadays, the local area network is so popular that the enterprises generally apply the local area network to access the internal data. Based on the related researches, it is discovered that some of the files and data used in the internal computers of the enterprises are repeatedly used, and therefore, the amount of repeatedly used files and data transmitted between the computers has to be decreased so as to reduce the load of each of the computers.

For example, the digital camera is connected to a computer via a transmission line so as to transmit the inside image data to the computer. Therefore, the computer can transmit the image data to a printer for printing out the image data, or the computer can re-transmit the image data to another computer. As results, the image data will be repeatedly stored in several computers so as to waste the system resources.

Therefore, by applying the local area network, a network storage device is provided for connecting the internal computers of the enterprise so as to store the repeatedly used or commonly shared files and data in the network storage device. The internal computers of the enterprise are connected to the local area network for accessing the files and data stored in the network storage device. Presently, the most usually used network storage device by the enterprises is a network attached storage (NAS) device capable of storing the shared files by the clients and servers with different platforms, including the Unix, Windows, Linux, Netware, and so on. Therefore, the object of transforming the file formats and sharing the resources of files and homepages between the different platforms can be achieved.

### SUMMARY OF THE INVENTION

In order to conveniently store the commonly shared files and data in the network storage device, the present invention applies the characteristics of the USB interface, high transmission rate and hot-swappability, to store the files and data to be shared from an externally connected USB device, such as a digital camera, to a network storage device via a USB interface. Therefore, a method and device capable of sharing the inside data of an externally connected USB device is provided. An input bottom is designed to be pressed for automatically copying the inside data of the externally connected USB device to the network storage device. The present invention provides the following means to achieve the object of automatically copying and sharing the inside data of the externally connected USB device.

The present invention provides a method capable of copying the inside data of the externally connected USB device. In this method, an input bottom is pressed so as to execute a copy process. First, it will be detected whether the USB interface is connected to an externally connected USB device. If yes, a fixed storage area is built in the network storage device, and then the inside data of the externally connected USB device will be read one by one. Thereafter, the data will be sequentially stored in the fixed storage area until all of the data is stored in the fixed storage area. Thus, the object of automatically copying the inside data of the externally connected USB device is achieved.

The present invention further provides a network storage device capable of sharing the inside data of the externally connected USB deice. The network storage device is connected to a local area network, and connected to at least one computer. The network storage device at least comprises at least one USB interface unit connected to the externally connected USB device, and at least one network interface unit connected to the local area network, a storage unit and a control unit. An input bottom is pressed to initiate a copy process for storing the digital data of the externally connected USB device in the storage unit so as to be shared by the computers connected to the local area network. Therefore, the object of commonly sharing the digital data of the externally connected USB device can be achieved.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a structure according to the present invention;

FIG. 2 is a block diagram of the network storage device 1 according to the present invention; and

FIG. 3 is a flowchart of the copy process according to the present invention.

### DETAILED DESCRIPTION OF THE PREFERRED EMBODIMENT

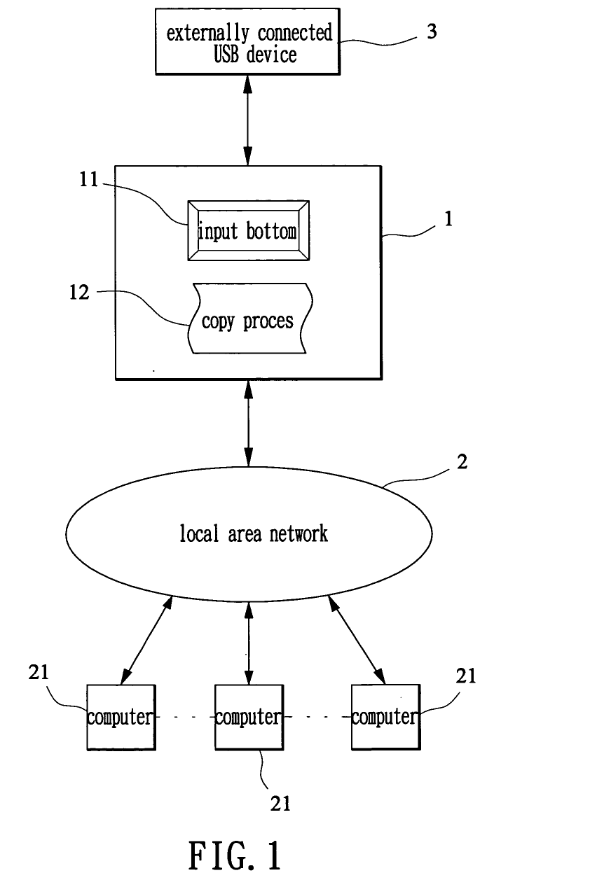

Please refer to FIG. 1. FIG. 1 is a perspective diagram of a structure according to the present invention. The present invention applies a network storage device 1, and the network storage device 1 can be a disk array server or a network attached storage (NAS) device to be connected to a local area network 2. The local area network 2 is connected to a plurality of computers 21.

The network storage device according to the present invention is further connected to an externally connected USB device 3, such as a digital camera, a memory card reader or a USB mobile disk, and so on. An input bottom 11 is installed on the device 3 to be pressed that a copy process 12 will be automatically executed to copy the digital data inside the externally connected USB device (such as the images) to the network storage device 1. Therefore, each of the computers 21 connected to the local area network 2 can commonly share the digital data in the network storage device.

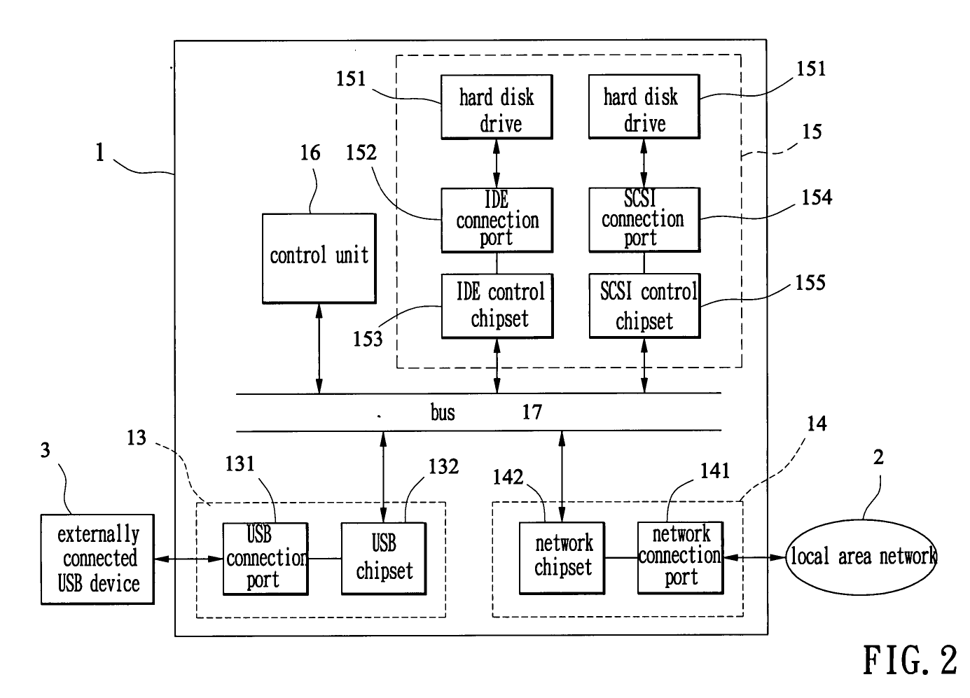

Please refer to FIG. 2. FIG. 2 is a block diagram of the network storage device 1 according to the present invention. The network storage device 1 comprises a USB interface unit 13, a network interface unit 14, a storage unit 15 and a control unit 16. The control unit 16 is connected to the USB interface unit 13, the network interface unit and the storage unit 15 via a bus 17. The control unit 16 is used for executing the copy process 12. The USB interface unit 13 further comprises a USB connection port 131 and a USB chipset 132. The USB connection port 131 is removably connected to the externally connected USB device 3, and the USB chipset 132 is connected to the USB connection port 131 and the bus 17 for controlling the data transformation between the USB connection port and the bus 17.

The network interface unit 14 further comprises a network connection port 141 and a network chipset 142. The network connection port 141 can be a RJ-45 connection port for an Ethernet, and is connected to the local area network 2 via a network line. The network chipset 142 is connected to the network connection port 141 and the bus 17 for controlling the data transformation between the network connection port 141 and the bus 17.

The storage unit 15 comprises a hard disk drive 151, such as an IDE interface hard disk drive or a SCSI interface hard disk drive, for storing digital data. When the hard disk drive 151 is the IDE interface hard disk drive, it has an IDE connection port 152 and an IDE control chipset 153. The IDE connection port can be connected to the hard disk drive 11, and the IDE control chipset 153 can be connected to the IDE connection port 152 and the bus 17 for controlling the data transformation between the IDE connection port 152 and the bus 17.

When the storage unit 15 is the SCSI interface hard disk drive, it has a SCSI connection port 154 and a SCSI control chipset 155. The SCSI connection port 154 is connected to the hard disk drive 151, and the SCSI control chipset 155 is connected to the SCSI connection port 154 and the bus 17 for controlling the data transformation between the SCSI connection port 154 and the bus 17.

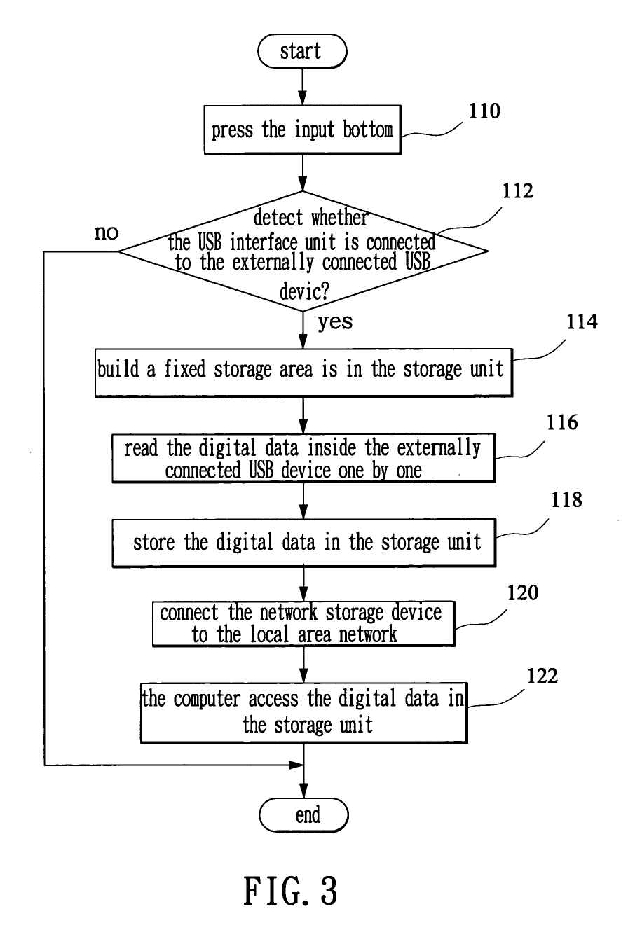

Please refer to FIG. 3. FIG. 3 is a flowchart of the copy process according to the present invention. The control unit 16 will execute the copy process. First, the input bottom 11 is pressed to initiate the copy process (110). Then, it is detected whether the USB interface unit 13 is connected to the externally connected USB device (112). If no, the copy process will be terminated. If yes, a fixed storage area is built in the storage unit 15 (114), and then the digital data inside the externally connected USB device 3 is read one by one (116). The read digital data will be sequentially stored in the fixed storage area of the network storage device 1 (118). When all of the digital data is copied, the copy process will be terminated.

When the digital data of the externally connected USB device is stored in the network storage device 1, the network storage device 1 has to be connected to the local area network 2 (120) so that the computers 21 connected to the local area network 2 can access the digital data stored in the fixed storage area of the storage unit 15 via the network interface 14 (122).

Those skilled in the art will readily observe that numerous modifications and alterations of the device may be made while retaining the teachings of the invention. Accordingly, the above disclosure should be construed as limited only by the metes and bounds of the appended claims.

1. A method for copying the inside data of an externally connected USB device to a network storage device, an input bottom being pressed to initiate a copy process, the method comprising:
a. building a fixed storage area in the network storage device;
b. reading the digital data inside the externally connected USB device; and
c. storing the data to the fixed storage area.

2. The method for copying the inside data of an externally connected USB device to a network storage device according to claim 1, wherein the externally connected USB device can be a digital camera, a memory card reader, or a USB mobile disk.

3. The method for copying the inside data of an externally connected USB device to a network storage device according to claim 1, wherein the network storage device is a disk array server.

4. The method for copying the inside data of an externally connected USB device to a network storage device according to claim 1, wherein the network storage device is network attached storage (NAS).

5. The method for copying the inside data of an externally connected USB device to a network storage device according to claim 1, wherein the step a further comprises:
detecting whether connected to the externally connected USB device;
if yes, then go to the step a; and
if no, then the copy process is terminated.

6. The method for copying the inside data of an externally connected USB device to a network storage device according to claim 5, wherein the externally connected USB device is connected via a USB interface.

7. The method for copying the inside data of an externally connected USB device to a network storage device according to claim 1, wherein in the step a, the network storage device comprises at least one hard disk drive.

8. The method for copying the inside data of an externally connected USB device to a network storage device according to claim 1, wherein in the step a, the fixed storage area is a file wrapper.

9. The method for copying the inside data of an externally connected USB device to a network storage device according to claim 1, wherein the digital data in the step b comprises at least one image data.

10. The method for copying the inside data of an externally connected USB device to a network storage device according to claim 1 further comprising the steps following the step c:
building a connection to a local area network, the local area network being connected to at least one computer; and
the computer accessing the digital data stored in the network storage device via the local area network.

11. The method for copying the inside data of an externally connected USB device to a network storage device according to claim 10, wherein the local area network is connected to the computer via an Ethernet interface.

12. A network storage device capable of sharing the inside data of an externally connected USB device being connected to a local area network, the local area network being connected to at least one computer, the network storage device comprising:
at least one USB interface unit connected to the externally connected USB device;
at least one network interface unit connected to the local area network;
a storage unit for storing digital data; and
a control unit connected to the USB interface unit, the network interface unit and the storage unit via a bus, wherein an input bottom is pressed to initiate a copy process for storing the digital data in the externally connected USB device in the storage unit so as to share the data with the computer connected to the local area network.

13. The device capable of sharing the inside data of an externally connected USB device according to claim 12, wherein the externally connected USB device can be a digital camera, a memory card reader or a USB mobile disk.

14. The device capable of sharing the inside data of an externally connected USB device according to claim 12, wherein the USB interface unit further comprises:
at least one USB connection port connected to the externally connected USB device; and
a USB chipset connected to the USB connection port and the bus for controlling the data transformation between the USB connection port and the bus.

15. The device capable of sharing the inside data of an externally connected USB device according to claim 12, wherein the network interface unit further comprises:
at least one network connection port connected to the local area network; and
a network chipset connected to the network connection port and the bus for controlling the data transformation between the network connection port and the bus.

16. The device capable of sharing the inside data of an externally connected USB device according to claim 15, wherein the network connection port is a RJ-45 connection port of an Ethernet.

17. The device capable of sharing the inside data of an externally connected USB device according to claim 12, wherein the storage unit comprises at least one hard disk drive.

18. The device capable of sharing the inside data of an externally connected USB device according to claim 17, wherein the hard disk drive can be an IDE interface hard disk drive or a SCSI interface hard disk drive.

19. The device capable of sharing the inside data of an externally connected USB device according to claim 18, wherein the IDE interface comprises:
at least one IDE connection port connected to the hard disk drive; and an IDE control chipset connected to the IDE connection port and the bus for controlling the data transformation between the IDE connection port and the bus.

20. The device capable of sharing the inside data of an externally connected USB device according to claim 18, wherein the SCSI interface comprises:
at least one SCSI connection port connected to the hard disk drive; and
a SCSI control chipset connected to the SCSI connection port and the bus for controlling the data transformation between the SCSI connection port and the bus.
